(19) United States
(12) Patent Application Publication
(10) Pub. No.: US 2026/0153834 A1
(43) Pub. Date: Jun. 4, 2026

(54) IMAGE FORMING APPARATUS

(71) Applicant: Kensuke KUMAOKA, Kanagawa (JP)

(72) Inventor: Kensuke KUMAOKA, Kanagawa (JP)

(21) Appl. No.: 19/390,723

(22) Filed: Nov. 17, 2025

(30) Foreign Application Priority Data
Dec. 3, 2024 (JP) 2024-210793

(51) Int. Cl. G03G 21/20; G03G 15/20

(52) U.S. Cl. CPC G03G 21/206; G03G 15/2017; G03G 15/2064; G03G 2215/00413

(57) ABSTRACT

An image forming apparatus includes a pair of exhaust ducts, exhaust fans, and a shared filter. The pair of exhaust ducts have air-intake openings at positions different from each other. The exhaust fans exhaust air from the pair of exhaust ducts. The shared filter are at outlets of the pair of exhaust ducts.

### CROSS-REFERENCE TO RELATED APPLICATION

This patent application is based on and claims priority pursuant to 35 U.S.C. § 119(a) to Japanese Patent Application No. 2024-210793, filed on Dec. 3, 2024, in the Japan Patent Office, the entire disclosure of which is hereby incorporated by reference herein.

### BACKGROUND

### Technical Field

The present disclosure relates to an image forming apparatus.

### Related Art

An image forming apparatus may include an exhaust duct provided with an exhaust fan. For example, an image forming apparatus includes a fixing unit that heats a toner image, which has been transferred to a recording medium, to fix the toner image on the recording medium, a first duct disposed adjacent to the fixing unit, and an exhaust fan that discharges air in the first duct outward from the body of the image forming apparatus. The first duct has a plurality of divided air flow paths, inside.

### SUMMARY

The present disclosure described herein provides an image forming apparatus that includes a pair of exhaust ducts, exhaust fans, and a shared filter. The pair of exhaust ducts have air-intake openings at positions different from each other. The exhaust fans exhaust air from the pair of exhaust ducts. The shared filter are at outlets of the pair of exhaust ducts.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic view of a configuration of an image forming apparatus;

FIG. 2 is a perspective view of a ventilation structure;

FIG. 3 is a plan view of the ventilation structure of FIG. 2;

FIG. 4 is a front view of the ventilation structure of FIG. 3;

FIG. 5 is an enlarged view of a part of the ventilation structure of FIG. 3; and

FIG. 6 is a schematic diagram illustrating the ventilation structure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

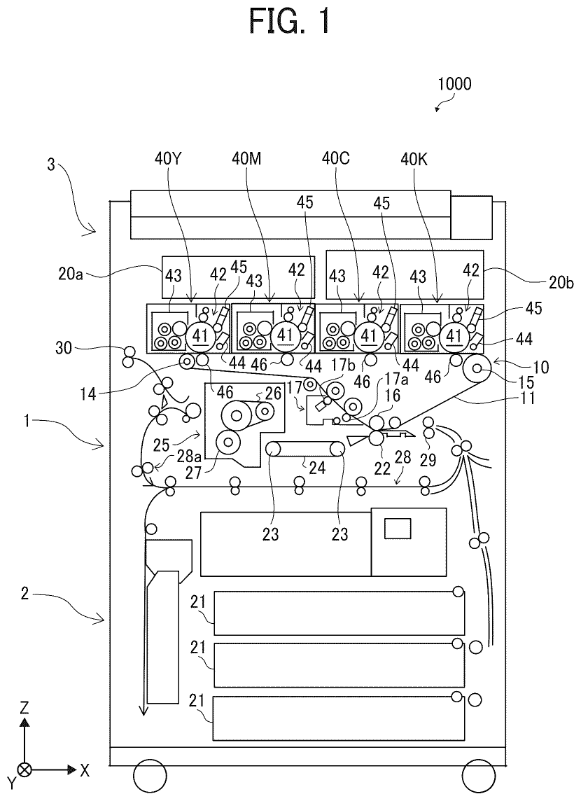

An electrophotographic copier 1000, which is an example of an image forming apparatus, will be described. First, a brief description of the copier 1000 will be given with FIG. 1. Referring to FIG. 1, the copier 1000 corresponds to a tandem electrophotographic apparatus that forms toner images different in color using respective dedicated process cartridges for the toner images and forms an image on a recording sheet in an intermediate transfer manner using an intermediate transfer belt 11. The copier 1000 has its vertically lowermost portion provided with a sheet feeder 2 that is multistage. An image former 1 is disposed above the sheet feeder 2 and a scanner 3 is disposed above the image former 1. The sheet feeder 2 has its each stage including a sheet feeding tray 21 that stores a stack of recording sheets as recording media, such as plain paper sheets, overhead projector (OHP) sheets, or intermediate paper sheets.

The image former 1 includes, almost at its center, a transfer device 10 including the intermediate transfer belt 11 that is endless and stretched around a plurality of rollers. The intermediate transfer belt 11 rotates (its surface runs) clockwise in FIG. 1. Four process cartridges 40Y, 40M, 40C, and 40K that form a yellow toner image, a magenta toner image, a cyan toner image, and a black toner image, respectively, are disposed in the direction in which the surface of the intermediate transfer belt 11 runs, above the intermediate transfer belt 11. In the following description, Y, M, C, and K as color signs are omitted as appropriate. Optical writing units 20a and 20b as two latent image writers are disposed above the four process cartridges 40Y, 40M, 40C, and 40K.

Each of the process cartridge 40Y, 40M, 40C, and 40K includes a photoconductor 41 that is drum-shaped and serves as a latent image bearer. Each photoconductor 41 is disposed so as to rotate counterclockwise in FIG. 1. A charging device 42, a developing device 43, a photoconductor cleaning device 44, and a lubricant applying device 45, which are publicly known, are disposed around each photoconductor 41.

Referring to FIG. 1, the transfer device 10 includes the intermediate transfer belt 11, a belt cleaning device 17, and four primary transfer rollers 46. The intermediate transfer belt 11 is stretched (tensioned) around a plurality of rollers including a stretching roller 14, a drive roller 15, and a secondary transfer counter roller 16. Then, based on rotation of the drive roller 15 due to a belt drive motor, the intermediate transfer belt 11 runs endlessly clockwise in FIG. 1.

The four primary transfer rollers 46 are each disposed in contact with the inner circumferential face of the intermediate transfer belt 11. The four primary transfer rollers 46 each receive a primary transfer bias applied from a power source. In addition, the four primary transfer rollers 46 each press the intermediate transfer belt 11 from the side of location of the inner circumferential face toward the corresponding photoconductor 41 such that a primary transfer nip is formed.

The transfer device 10 further includes a secondary transfer roller 22 as a constituent of a secondary transferrer below the intermediate transfer belt 11. The secondary transfer roller 22 presses against the secondary transfer counter roller 16 through the intermediate transfer belt 11. The belt cleaning device 17 is disposed on the downstream side of the secondary transfer counter roller 16 in the direction in which the surface of the intermediate transfer belt 11 runs. The belt cleaning device 17 includes a belt cleaning brush roller 17a that drives rotationally and a brush roller 17b as a lubricant applying mechanism.

A fixing device 25 is disposed on the downstream side of the secondary transfer roller 22 in the direction of sheet conveyance and fixes a toner image formed on a recording sheet to the surface of the recording sheet. A pressure roller 27 is pressed against a fixing belt 26 that is endless. The recording sheet after image transfer is conveyed to the fixing device 25 by a conveyance belt 24 that is endless and bridged between a pair of rollers 23. A sheet reversing device 28 is disposed below the secondary transfer roller 22 and reverses a sheet for formation of an image on both the front and back faces of the sheet. The sheet reversing device 28 includes a conveyance roller 28a.

In a case where the copier 1000 including the above-described constituents copies a color original document, the scanner 3 reads an image in the document set on a contact glass. With the intermediate transfer belt 11 rotating, a toner image is formed on each photoconductor 41 in a publicly known image forming process. Next, the respective toner images formed on the photoconductors 41 are overlaid on the intermediate transfer belt 11 due to sequential primary transfer to form a four-color composite toner image on the intermediate transfer belt 11.

In parallel with an image forming operation for the four-color composite toner image on the intermediate transfer belt 11, recording sheets are individually fed from the sheet feeding tray 21 selected in the sheet feeder 2 for conveyance to a registration roller 29. The registration roller 29 starts to rotate at a timing such that a predetermined positional relationship is fulfilled between the four-color composite toner image formed on the intermediate transfer belt 11 and the front end of a recording sheet. Thus, the four-color composite toner image on the intermediate transfer belt 11 is secondary-transferred to a predetermined position on the recording sheet by the secondary transfer roller 22, so that a full-color toner image is formed on the recording sheet.

The recording sheet on which the full-color toner image is formed is conveyed to the fixing device 25 on the downstream side of the secondary transfer roller 22 in the direction of sheet conveyance. The fixing device 25 fixes the full-color toner image, which is secondary-transferred by the secondary transfer roller 22, to the recording sheet. The recording sheet to which the full-color toner image is fixed is ejected outward from the copier 1000 by a sheet ejection roller 30. In a double-sided print mode to form an image on both faces of a recording sheet, a recording sheet having a first face to which a full-color toner image is fixed is discharged from the fixing device 25 and then is conveyed to the sheet reversing device 28. After the sheet reversing device 28 reverses the front and back faces of the recording sheet, the recording sheet is conveyed to the registration roller 29, again. Then, the recording sheet has a second face on which a full-color image is formed through the secondary transfer roller 22 and the fixing device 25.

The copier 1000 includes a ventilation structure 300 that suppresses the amount of fine particles that are generated from the fixing device 25 or components therearound and are discharged outward from the copier 1000. The ventilation structure 300 includes an exhaust duct for cooling the pressure roller 27 in the fixing device 25 (in the following description, referred to as a roller-cooling exhaust duct) and a drive-member exhaust duct for a drive member in the pressure roller 27 or a drive member in a conveyor that conveys a recording sheet having passed through the pressure roller 27 in a housing. According to the configuration, mutually different flows of air can be generated in the mutually different ducts. The ventilation structure 300 includes a fan at one of the outlets of the two exhaust ducts and a fan at the other. The air exhausted from the outlets is exhausted outward from the copier 1000 through a single filter.

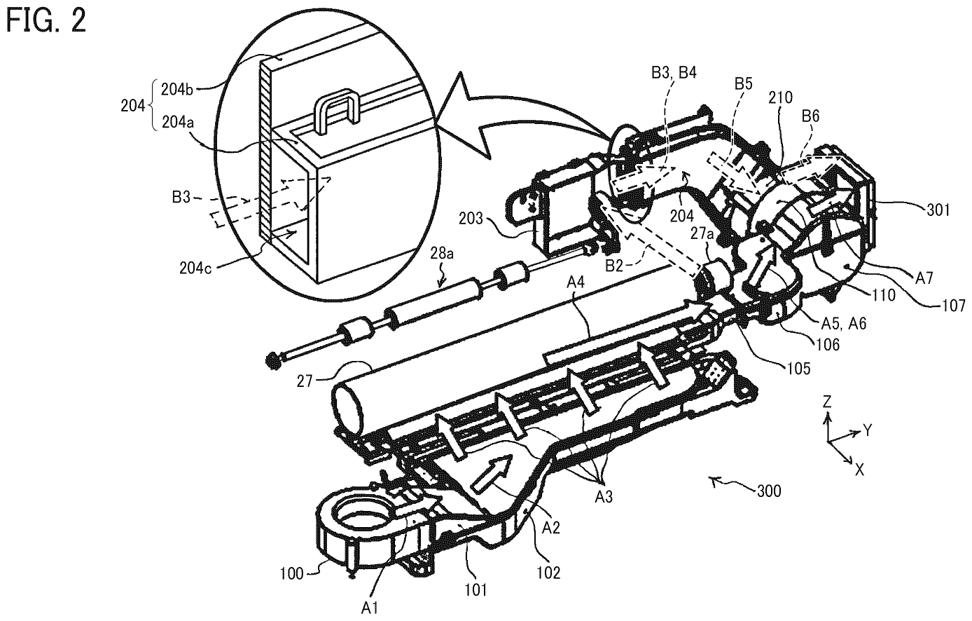

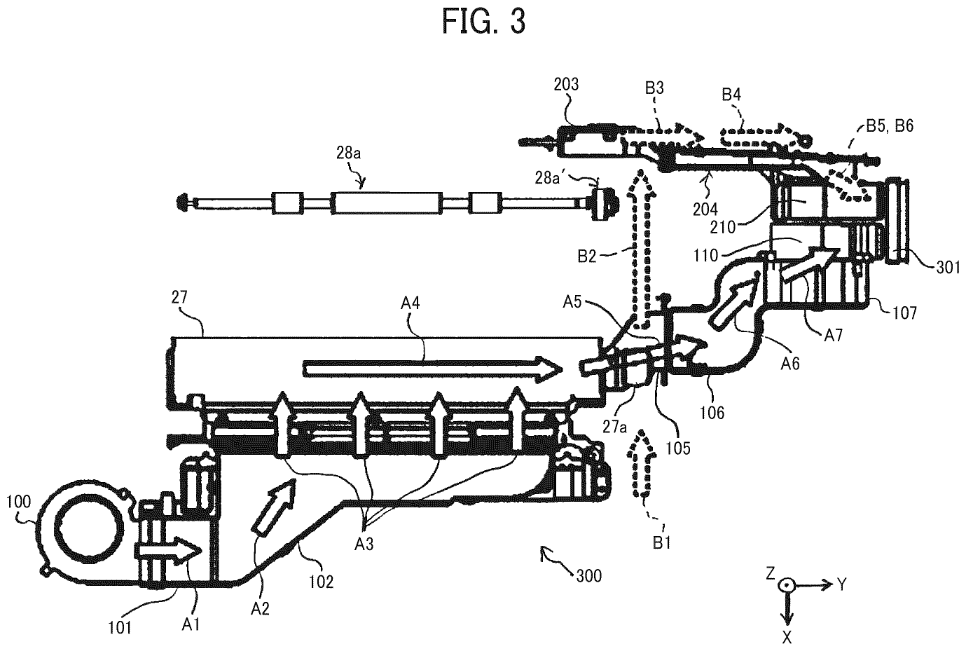

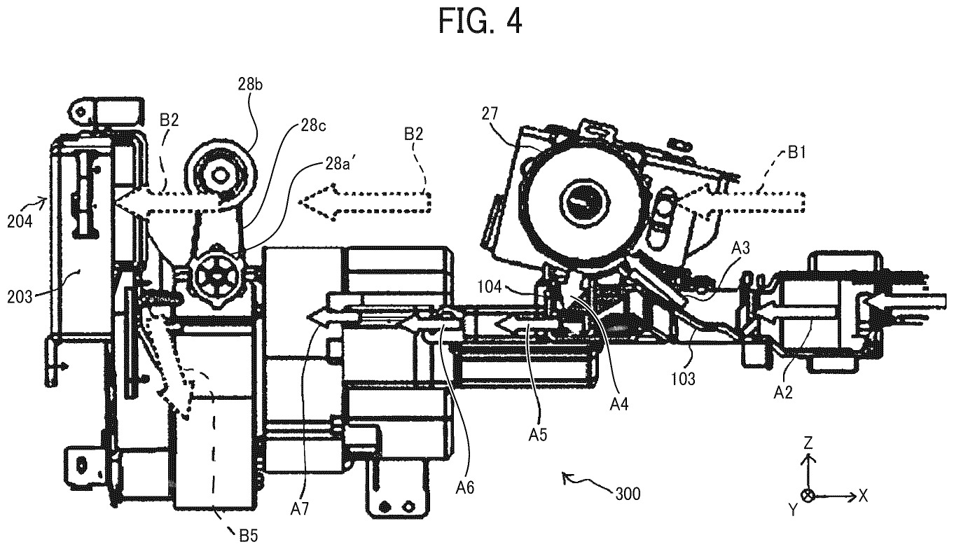

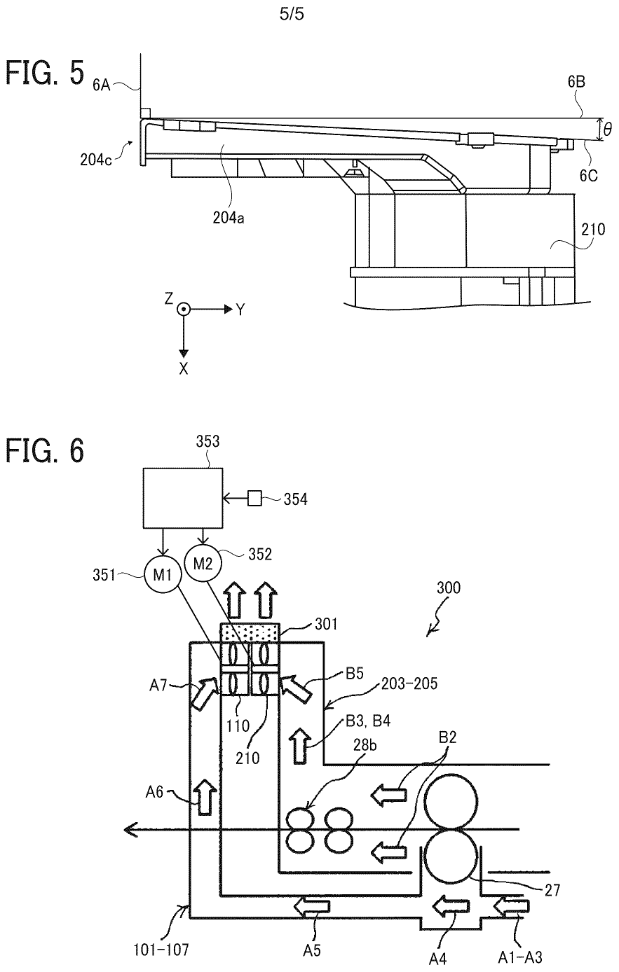

FIG. 2 is a perspective view of the ventilation structure 300. FIG. 3 is a plan view of the ventilation structure 300. FIG. 4 is a front view of the ventilation structure 300. FIG. 5 is a enlarged view of a part of the ventilation structure 300 of FIG. 3. As illustrated in FIGS. 3 and 4, the roller-cooling exhaust duct for the pressure roller 27 includes ducts 101, 102, 103, 104, 105, 106, and 107 of which the inner spaces for flows of air A1 to A6 are in communication. A sirocco fan 100 of a double-suction type or a single-suction type blows air into the duct 101 as the first duct. The duct 107 as the last duct is connected to a fan 110.

The drive-member exhaust duct includes ducts 204 and 205 of which the inner spaces are in communication. The inner spaces are intended for receiving, as a flow of air B3, air that is received by an airflow receiving member 203 after passing through the drive member as flows of air B1 and B2 and for guiding the air as flows of air B4 and B5. The duct 204 as the first duct receives the flow of air B3 from the airflow receiving member 203 through an opening 204c, which is an example of an air-intake opening. The duct 205 as the last duct is connected to a fan 210.

A flow of air A7 discharged from the fan 110 of the roller-cooling exhaust duct and a flow of air B6 discharged from the fan 210 of the drive-member exhaust duct are discharged from the ventilation structure 300 as a common ventilation structure through a filter 301 as a common filter provided to the ventilation structure 300.

As illustrated in FIGS. 2 and 3, the drive-member exhaust duct receives and guides the flows of air B1 and B2 having passed through the drive member disposed on the side closer to the back of the copier 1000. In the example of FIGS. 2 and 3, a drive transmitter for a gear 27a that receives driving on the side closer to the back of the copier 1000 of the pressure roller 27 and a drive member on the side closer to the back of the copier 1000 for the conveyance roller 28a are provided. As illustrated in FIG. 4, the conveyance roller 28a has a gear 28a′ receives driving from a drive pulley 28b through a timing belt 28c. Use of grease for the gear 27a and the timing belt 28c causes fine particles, and thus the roller-cooling exhaust duct alone may not capture all of the fine particles.

In the ventilation structure 300, the drive-member exhaust duct provided separately from the roller-cooling exhaust duct captures air containing fine particles generated by the drive member and discharges the air from which the fine particles are removed through the filter 301 outward from the copier 1000, so that the fine particles generated by the drive member can be inhibited from being discharged outward from the copier 1000.

As illustrated in FIG. 5, the duct 204 having the opening 204c includes a resin duct member 204a and a metal plate 204b (refer to FIG. 2) screwed together such that the resin duct member 204a has an opening, located above the middle of FIG. 5, covered with the metal plate 204b. The resin duct member 204a has a face 6C on the parting line side of the resin duct member 204a, namely, a contact face with the metal plate 204b, at an angle θ of 1° to 5° with respect to a perpendicular 6B to an imaginary opening plane 6A of the opening 204c.

Thus, unlike a configuration in which a flow path has a sharp change in angle (sharp bend) inside, no increase is made in pressure loss and no convection occurs. Therefore, even in the case of installation at a small place, a minimum pressure loss can be achieved. For example, even at a small place where avoidance of other components is required, a low pressure loss can be achieved with the other components avoided due to a gentle incline.

FIG. 6 schematically illustrates the ventilation structure 300. The fans 110 and 210 are driven, respectively, by motors M1 and M2 that are independent of each other. The motors M1 and M2 are referred to as motors 351 and 352, respectively, in FIG. 6. A controller 353 controls the driving of the motors M1 and M2. From the viewpoint of temperature control of the fixing device 25 using a temperature sensor 354, the fan 110 of the roller-cooling exhaust duct is restricted in driving.

For example, in the case of an exhaust system for reducing the exhaust amount of fine particles, fine particles generated from an inner roller of a fixing pressure roller may be discharged outward from an apparatus using a fixing-pressure-roller cooling duct, simultaneously with roller cooling. In a system in which a fan serving as a cooler for a fixing pressure roller sucks fine particles to discharge the fine particles outward from the apparatus through a filter, because of dominant temperature control of fixing, fine particles in the apparatus are difficult to collect constantly and thus the fine particles remaining in the apparatus may leak outward from the apparatus through an outlet, which is not a target place. A duct serving for cooling a fixing pressure roller and exhausting fine particles fails to collect fine particles generated from the grease of a drive gear, so that the fine particles leak outward from the apparatus.

In contrast, in the ventilation structure 300, the driving of the fan can be controlled independently of fixing since the drive-member exhaust duct provided separately from the roller-cooling exhaust duct is provided with an independent fan. Thus, fine particles generated near the area of driving for fixing can be collected at a constant volume of air without the influence of temperature control of fixing.

The collected fine particles are exhausted through a filter the same as the filter provided to the outlet of the roller-cooling exhaust duct, so that the filters become dirty at the same rate. Thus, the filters can be replaced at the same time, leading to minimum workability and cost.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An image forming apparatus, comprising:
a pair of exhaust ducts having air-intake openings at positions different from each other;
exhaust fans to exhaust air from the pair of exhaust ducts; and
a shared filter at outlets of the pair of exhaust ducts.

2. The image forming apparatus according to claim 1, further comprising:
a fixing device including a fixing member to fix an image on a recording medium;
and a conveyor to convey the recording medium having passed through the fixing device,
wherein the pair of exhaust ducts includes
an exhaust duct for the fixing member, and
an exhaust duct for a driver of the fixing device or a driver of the conveyor.

3. The image forming apparatus according to claim 1,
wherein at least one of the pair of exhaust ducts includes a metal plate and a resin duct member having an opening covered with the metal plate, and
the resin duct member has a contact face with the metal plate, at an angle of 1° to 5° with respect to a perpendicular to an imaginary opening plane of an air-intake opening of the at least one of the pair of exhaust ducts.
